(19) United States
(12) Patent Application Publication
(10) Pub. No.: US 2015/0352495 A1
(43) Pub. Date: Dec. 10, 2015

(54) CATALYST AND METHOD FOR THE REDUCTION OF NITROGEN OXIDES

(71) Applicant: UMICORE AG & CO. KG, Hanau-Wolfgang (DE)

(72) Inventors: Ruediger HOYER, Alzenau-Hoerstein (DE); Anke SCHULER, Woerth (DE); Thomas UTSCHIG, Frankfurt am Main (DE); Elena MUELLER, Pfungstadt (DE)

(73) Assignee: UMICORE AG & CO. KG, Hanau-Wolfgang (DE)

(21) Appl. No.: 14/763,241

(22) PCT Filed: Feb. 21, 2014
(86) PCT No.: PCT/EP2014/053383

§ 371 Date: Jul. 24, 2015

(30) Foreign Application Priority Data
Feb. 21, 2013 (EP) 13156095.5

(51) Int. Cl. B01D 53/94; B01J 35/02; B01J 23/46; B01J 35/00; B01J 23/10; B01J 23/44

(52) U.S. Cl. CPC B01D 53/9481; B01J 23/10; B01J 23/44; B01J 23/464; B01J 35/0006; B01J 35/02; B01D 2255/9022; B01D 2255/91; B01D 2255/40; B01D 2255/1021; B01D 2255/1023; B01D 2255/1025

(57) ABSTRACT

The present invention relates to a nitrogen oxide storage catalyst composed of at least two catalytically active washcoat layers on a support body, wherein a lower washcoat layer A contains cerium oxide, an alkaline earth metal compound and/or an alkali metal compound, and also platinum, and an upper washcoat layer B disposed atop the washcoat layer A, containing cerium oxide, and also platinum and palladium, and no alkaline earth metal compound, and a method for converting NOₓ in the exhaust gases of motor vehicles which are operated with lean-burn engines.

The present invention relates to a catalyst for reducing nitrogen oxides, which is present in the exhaust gas of lean-burn internal combustion engines.

The exhaust gas of motor vehicles which are operated with lean-burn internal combustion engines, for example with diesel engines, contains not only carbon monoxide (CO) and nitrogen oxides (NOₓ) but also constituents which originate from the incomplete combustion of the fuel in the combustion chamber of the cylinder. These include, as well as residual hydrocarbons (HCs), which are usually likewise predominantly in gaseous form, particulate emissions, also referred to as “diesel soot” or “soot particles”. These are complex agglomerates of predominantly carbonaceous solid particles and an adhering liquid phase usually consisting mainly of longer-chain hydrocarbon condensates. The liquid phase adhering on the solid constituents is also referred to as soluble organic fraction (SOF) or volatile organic fraction (VOF).

To treat these exhaust gases, said constituents have to be converted very substantially to harmless compounds, which is only possible using suitable catalysts.

For removal of the nitrogen oxides, what are called nitrogen oxide storage catalysts, for which the term “lean NOx trap” or LNT is also customary, are known. The treating effect thereof is based on storage of the nitrogen oxides by the storage material of the storage catalyst predominantly in the form of nitrates in a lean operating phase of the engine, and breakdown thereof in a subsequent rich operating phase of the engine, and reaction of the nitrogen oxides thus released with the reducing exhaust gas components over the storage catalyst to give nitrogen, carbon dioxide and water. This way of working is described, for example, in the SAE document SAE 950809.

Useful storage materials especially include oxides, carbonates or hydroxides of magnesium, calcium, strontium, barium, the alkali metals, the rare earth metals or mixtures thereof. Because of their basic properties, these compounds are capable of forming nitrates with the acidic nitrogen oxides in the exhaust gas and of storing them in this way. To produce a high interaction area with the exhaust gas, they are deposited with maximum dispersion on suitable support materials. Nitrogen oxide storage catalysts additionally generally contain noble metals such as platinum, palladium and/or rhodium as catalytically active components. Their first task is to oxidize NO to NO₂, and CO and HC to CO₂, under lean conditions, and their second task is to reduce NO₂ released during the rich operating phases in which the nitrogen oxide storage catalyst is being regenerated to nitrogen.

With the change in the exhaust gas legislation according to Euro 6, future exhaust gas systems will have to have adequate NOₓ conversion both at cold temperatures in a town cycle and at high temperatures as occur at high loads. But known nitrogen oxide storage catalysts exhibit marked NOₓ storage either at low temperatures or at high temperatures. It has not been possible to date to achieve a good NOₓ conversion over a broad temperature range from 200 to 450° C., which is essential for satisfaction of future exhaust gas legislation.

EP 0 885 650 A2 describes an exhaust gas treatment catalyst for internal combustion engines having two catalytically active layers on a support body. The layer present on the support body comprises one or more finely dispersed alkaline earth metal oxides, at least one platinum group metal, and at least one finely divided oxygen-storing material. The platinum group metals here are in close contact with all the constituents of the first layer. The second layer is in direct contact with the exhaust gas and contains at least one platinum group metal, and at least one finely divided oxygen-storing material. Only a portion of the fine solids in the second layer serves as a support for the platinum group metals. The catalyst is a three-way catalyst which converts the harmful exhaust gas components under essentially stoichiometric conditions, i.e. at the air ratio λ of 1.

US2009/320457 discloses a nitrogen oxide storage catalyst comprising two superposed catalysts on a support substrate. The lower layer directly atop the support substrate comprises one or more noble metals, and one or more nitrogen oxide storage components. The upper layer comprises one or more noble metals and cerium oxide, and is free of alkali metal or alkaline earth metal components.

Catalyst substrates which contain nitrogen oxide storage materials and two or more layers are also described in WO 2012/029050. The first layer is directly atop the support substrate and comprises platinum and palladium, while the second layer is atop the first and comprises platinum. Both layers also contain one or more oxygen storage materials and one or more nitrogen oxide storage materials comprising one or more alkali metals and/or alkaline earth metals. The total amount of alkali metal and alkaline earth metal in the nitrogen oxide storage materials is 0.18 to 2.5 g/in³, calculated as M₂O and alkaline earth metal oxide MO.

The present invention relates to a nitrogen oxide storage catalyst composed of at least two catalytically active washcoat layers on a support body, wherein
a lower washcoat layer A contains cerium oxide, an alkaline earth metal compound and/or an alkali metal compound, and also platinum, and
an upper washcoat layer B disposed atop the washcoat layer A contains cerium oxide, and also platinum and/or palladium, and no alkaline earth metal compound,
   and wherein the washcoat layer B is present in an amount of 50 to 200 g/L, based on the volume of the support body, and the minimum proportion by mass in % of cerium oxide in the washcoat layer B is calculated from the formula

0.1×amount of washcoat layer B in g/L+30.

The cerium oxide used in the washcoat layers A and B may be of commercial quality, i.e. have a cerium oxide content of 90% to 100% by weight.

In one embodiment of the present invention, cerium oxide is used in the washcoat layer A in an amount of 30 to 120 g/L, especially 30 to 80 g/L.

In the washcoat layer B the minimum proportion by mass in % of cerium oxide is calculated by the abovementioned formula. The expression “amount of washcoat layer B in g/L” in this formula is understood to mean the dimensionless number which corresponds to the amount of the washcoat layer B reported in g/L.

For a washcoat loading of 50 g/L, a minimum proportion by mass of cerium oxide of 35% is thus calculated, corresponding to 17.5 g/L, based on the volume of the support body.

For a washcoat loading of 200 g/L, a minimum proportion by mass of cerium oxide of 50% is thus calculated, corresponding to 100 g/L, based on the volume of the support body.

In one embodiment of the present invention, the proportion by mass of cerium oxide in the washcoat layer B is at least 50%, which corresponds to amounts of at least 25 to 100 g/L, based on the volume of the support body, according to the total loading of washcoat layer B.

In a further embodiment of the present invention, the washcoat layer B is present in an amount of 75 to 150 g/L, based on the volume of the support body. Accordingly, in this case, the amounts of cerium oxide are at least 28.1 to 67.5 g/L, based in each case on the volume of the support body.

In a further embodiment of the present invention, the washcoat layer B is present in an amount of 80 to 130 g/L, based on the volume of the support body. Accordingly, in this case, the amounts of cerium oxide are at least 30.4 to 55.9 g/L, based in each case on the volume of the support body.

The upper limit in the amount of cerium oxide present in washcoat layer B is calculated from the maximum washcoat loading of 200 g/L minus the amounts of noble metal and the support materials for the noble metals, and any further constituents present in washcoat layer B.

In preferred embodiments of the present invention, however, washcoat layer B does not contain any further constituents apart from cerium oxide, noble metal and support materials for the noble metal.

The maximum amount of cerium oxide which may be present in washcoat layer B can thus be calculated in a simple manner.

In one embodiment of the present invention, washcoat layer B does not just contain no alkaline earth metal compound but also contains no alkali metal compound.

The washcoat layer A contains platinum or platinum and palladium. In the latter case, the ratio of platinum to palladium is 1:2 to 20:1, especially 1:1 to 10:1, for example 1:1, 2:1, 4:1 and 10:1.

The washcoat layer B contains platinum or palladium; in preferred embodiments of the present invention, it contains platinum or platinum and palladium. In the latter case, the ratio of platinum to palladium is 1:2 to 20:1, especially 1:1 to 10:1, for example 1:1, 2:1, 4:1 and 10:1.

In embodiments of the present invention, washcoat layer A and/or washcoat layer B contains rhodium as further noble metal. Rhodium in this case is present especially in amounts of 0.1 to 10 g/ft³ (corresponding to 0.003 to 0.35 g/L), based on the volume of the support body.

Both in washcoat layer A and in washcoat layer B, the noble metals platinum and/or palladium and any rhodium are typically present on suitable support materials. Materials of this kind used are high-surface area, high-melting oxides, for example aluminum oxide, silicon dioxide, titanium dioxide, but also mixed oxides, for example mixed cerium-zirconium oxides. In embodiments of the present invention, the support material used for the noble metals is aluminum oxide, especially that stabilized by 1% to 6% by weight, especially 4% by weight, of lanthanum oxide.

It is preferable when the noble metals platinum, palladium and/or rhodium are supported only on one or more of the abovementioned support materials and are thus not in close contact with all the constituents of the respective washcoat layer.

Useful alkaline earth metal compounds in the washcoat layer A are especially oxides, carbonates or hydroxides of strontium and barium, particularly barium oxide and strontium oxide.

Useful alkaline metal compounds in the washcoat layer A are especially oxides, carbonates or hydroxides of lithium, potassium and sodium.

In embodiments of the present invention, the alkaline earth metal or alkali metal compound is present in amounts of 10 to 50 g/L, particularly 15 to 20 g/L, calculated as alkaline earth metal oxide or alkali metal oxide.

In a preferred embodiment, the present invention relates to a nitrogen oxide storage catalyst composed of at least two catalytically active washcoat layers on a support body,

wherein
a lower washcoat layer A contains
   cerium oxide in an amount of 30 to 80 g/L,
   platinum and palladium in a ratio of 10:1, and
   barium oxide; and
an upper washcoat layer B is disposed atop the lower washcoat layer A and contains
   no alkaline earth metal compound and no alkali metal compound,
   platinum and palladium in a ratio of 10:1, and
   cerium oxide in an amount of 40 to 100 g/L,
      wherein the washcoat layer B is present in amounts of 80 to 130 g/L and wherein the unit g/L is based in each case on the volume of the support body.

The application of the catalytically active washcoat layers A and B to the support body is effected by the customary dip-coating methods or pumping and suction coating methods with subsequent thermal aftertreatment (calcination and optionally reduction with forming gas or hydrogen). These methods are sufficiently well known from the prior art.

The nitrogen oxide storage catalysts of the invention are outstandingly suitable for conversion of NOₓ in exhaust gases of motor vehicles which are operated with lean-burn engines, for instance diesel engines. They attain a good NOx conversion at temperatures of about 200 to 450° C. without any adverse effect on NOx conversion at high temperatures. The nitrogen oxide storage catalysts of the invention are thus suitable for Euro 6 applications.

The present invention thus also relates to a method for converting NOₓ in exhaust gases of motor vehicles which are operated with lean-burn engines, for instance diesel engines, which is characterized in that the exhaust gas is passed over a nitrogen oxide storage catalyst composed of at least two catalytically active washcoat layers on a support body,

wherein
a lower washcoat layer A contains cerium oxide, an alkaline earth metal compound and/or an alkali metal compound, and also platinum, and
an upper washcoat layer B disposed atop the washcoat layer A contains cerium oxide, and also platinum and/or palladium, and no alkaline earth metal compound,
   and wherein the washcoat layer B is present in an amount of 50 to 200 g/L, based on the volume of the support body, and the minimum proportion by mass in % of cerium oxide in the washcoat layer B is calculated from the formula

0.1×amount of washcoat layer B in g/L+30.

Configurations of the method of the invention with regard to the nitrogen oxide storage catalyst correspond to the descriptions above.

The invention is elucidated in detail in the examples and figures which follow.

FIG. 1: NOx conversion of catalysts C1, CC1A as a function of temperature.

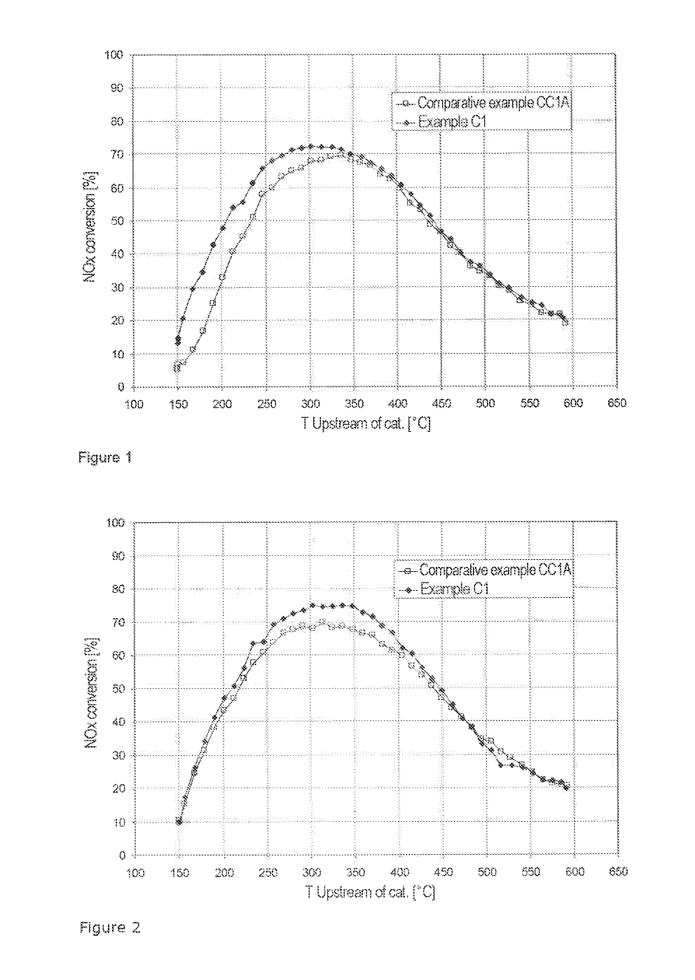

FIG. 2: NOx conversion of catalysts C2 and CC2A as a function of temperature.

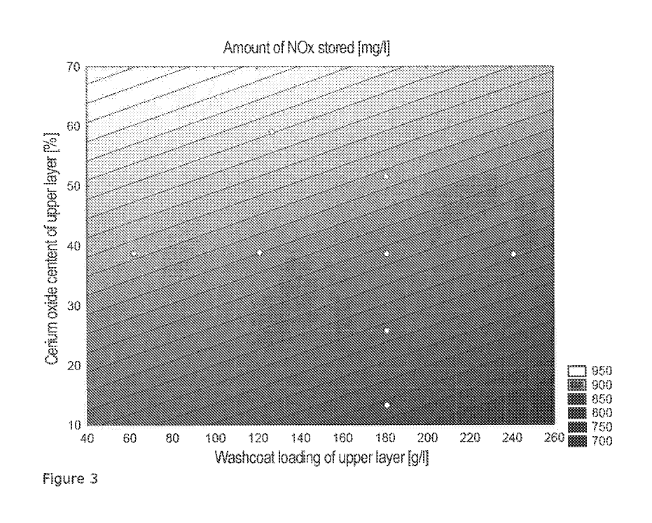

FIG. 3: mass of NOx stored in the first 800 s of an NEDC driving cycle based on the catalyst volume as a function of the washcoat loading of the upper washcoat layer B and the proportion by mass of cerium oxide in the washcoat layer B.

### EXAMPLE 1

For production of a catalyst of the invention, a ceramic support in honeycomb form is coated with a first washcoat layer A containing Pt and Pd supported on a lanthanum-stabilized alumina, cerium oxide in an amount of 47 g/L, and 17 g/L of barium oxide and 15 g/L of magnesium oxide. The loading of Pt and Pd is 50 g/cft (1.766 g/L) and 5 g/cft (0.177 g/L) and the total loading of the washcoat layer is 181 g/L based on the volume of the ceramic support. Applied to the first washcoat layer is a further washcoat layer B likewise containing Pt and Pd, and also Rh, supported on a lanthanum-stabilized alumina. The loading of Pt, Pd and Rh in this washcoat layer is 50 g/cft (1.766 g/L), 5 g/cft (0.177 g/L) and 5 g/cft (0.177 g/L). The washcoat layer B also contains 93 g/L of cerium oxide with a washcoat loading of layer B of 181 g/L.

The catalyst thus obtained is called C1 hereinafter.

### Comparative Examples 1a to 1c

Comparative examples 1a to 1c differ from example 1 in that the amounts of cerium oxide in the washcoat layer A and B are varied with a constant amount of cerium oxide of 140 g/L and a constant washcoat loading of washcoat layers A and B. The cerium oxide division in comparative examples 1a to 1c is apparent from table 1 below.

The catalysts thus obtained are called CC1A, CC1B and CC1C hereinafter.

### EXAMPLE 2

Example 2 differs from the preceding examples in that the lower washcoat layer A has a washcoat loading of 300 g/L and an amount of cerium oxide of 116 g/L. In contrast, the upper washcoat layer B has a washcoat loading of 62 g/L and a cerium oxide loading of 24 g/L. This corresponds to a cerium oxide content in the washcoat layer B of 39%.

The catalyst thus obtained is called C2 hereinafter.

### Comparative Examples 2a to 2c

Comparative examples 2a to 2c differ from example 2 in that the washcoat loadings of washcoat layers A and B are varied, with the total washcoat loadings of the two layers at a constant 362 g/L. The cerium oxide content in the washcoat layer B is likewise constant at 39% and the total amount of cerium oxide is constant at 140 g/L, based on the catalyst volume. The washcoat loadings of washcoat layer B and the amounts of cerium oxide in washcoat layers A and B are apparent from table 1 below.

The catalysts thus obtained are called CC2A, CC2B and CC2C hereinafter.

### EXAMPLE 3

Example 3 differs from the preceding examples in that the lower washcoat layer A has a washcoat loading of 235 g/L and an amount of cerium oxide of 65 g/L. In contrast, the upper washcoat layer B has a washcoat loading of 127 g/L and a cerium oxide loading of 75 g/L. This corresponds to a cerium oxide content in the washcoat layer B of 75%.

The catalyst thus obtained is called C2 hereinafter.

Prior to the conduction of comparative tests, all the catalysts from the above examples and comparative examples were aged under an alternating rich/lean atmosphere at 750° C. for 16 h. Each rich phase lasted for 60 s and contained 4% by volume of CO, while the lean phase likewise lasted for 60 s and contained 10% by volume of O₂. Over the entire aging operation, 10% by volume of H₂O was additionally metered in.

US2009/320457 shows, in FIG. 8, that example catalyst 1, compared to a catalyst A, has improved NOx conversion at temperatures of <300° C., but poorer conversion at T>350° C. Example catalyst 1 has two washcoat layers, the first layer having a washcoat loading of 1.7 g/in³ (104 g/L) and the second layer a washcoat loading of 2.6 g/in³ (159 g/L). No clear statements are made as to the amount of cerium oxide in the second washcoat layer.

FIG. 1 shows the NOx conversion of the inventive catalyst C1 and of the comparative catalyst CC1A as a function of the temperature upstream of the catalyst in a model gas reactor. While the temperature is being lowered from 600° C. to 150° C. at 7.5° C. per minute, the catalyst is contacted alternately with “lean” exhaust gas for 80 s and with “rich” exhaust gas for 10 s. During the test, a constant 500 ppm of NO and 33 ppm of propene, and also 17 ppm of propane, are metered in.

The comparison of catalysts C1 and CC1A in FIG. 1 shows that the inventive catalyst C1 has an improved NOx conversion at temperatures of <350° C., whereas the NOx conversion has remained the same at higher temperatures.

FIG. 2 shows the NOx conversion of the inventive catalyst C2 and of the comparative catalyst CC2A as a function of the temperature upstream of the catalyst, measured by the same procedure as in FIG. 1. It is found here that reducing the washcoat loading of washcoat layer B with a constant cerium oxide content can enhance the NOx conversion.

Table 1 shows a summary of all the catalysts. Additionally shown is the amount of NOx stored, based on the catalyst volume in the first 800 s of an NEDC driving cycle. For this purpose, the exhaust gas of a typical Euro 6 diesel engine is simulated in a model gas reactor and passed over the catalyst sample. The first 800 s of the NEDC driving cycle show the NOx storage characteristics at temperatures of <200° C. In order to satisfy the Euro 6 exhaust gas standard, it is particularly important to show a high NOx storage capacity in this range. The values for the mass of NOx stored in table 1 show that only in the inventive examples is the storage capacity >850 mg/L based on the catalyst volume.

TABLE 1

| | Cerium | Cerium | Proportion | Wash- | Amount |
|---|---|---|---|---|---|
| | oxide | oxide | by mass of | coat | of NOx |
| Cata- | washcoat | washcoat | cerium oxide | loading | stored |
| lyst | A [g/L] | B [g/L] | in B [%] | in B [g/] | [g/L] |
| CC1A | 116 | 24 | 13 | 181 | 732 |
| CC1B | 93 | 47 | 26 | 181 | 746 |
| CC1C | 70 | 70 | 39 | 181 | 777 |
| C1 | 47 | 93 | 52 | 181 | 868 |
| CC2A | 47 | 93 | 39 | 241 | 796 |
| CC2B | 70 | 70 | 39 | 181 | 809 |
| CC2C | 93 | 47 | 39 | 121 | 850 |
| C2 | 116 | 24 | 39 | 62 | 860 |
| C3 | 65 | 75 | 59 | 127 | 870 |

FIG. 3 shows the relationship between the amount of NOx stored in the first 800 s of an NEDC driving cycle and the washcoat loading of washcoat layer B and the cerium oxide content therein. The points above the black line correspond to the inventive examples having adequate NOx storage properties. The cerium oxide content in the washcoat layer B therefore has to correspond at least to the proportion calculated by the following formula:

minimum cerium oxide content in the washcoat layer B [%]=0.1×washcoat loading B [g/L]+30.

### EXAMPLE 4

A further inventive catalyst is obtained when, proceeding from catalyst C2 of example 2, an amount of cerium oxide in the washcoat layer B of 40 g/L is chosen. This corresponds to a cerium oxide content in the washcoat layer B of 64.5%.

### EXAMPLE 5

A further inventive catalyst is obtained when, proceeding from catalyst C1 of example 1, an amount of cerium oxide in the washcoat layer B of 145 g/L is chosen. This corresponds to a cerium oxide content in the washcoat layer B of 80%.

### EXAMPLE 6

For production of a further inventive catalyst, a ceramic support in honeycomb form is coated with a first washcoat layer A containing Pt and Pd in combination with a mixed magnesium-aluminum oxide, cerium oxide in an amount of 160 g/L, and 18 g/L of barium oxide. The loading of Pt and Pd is 60 g/cft (2.119 g/L) and 6 g/cft (0.212 g/L) and the total loading of the washcoat layer is 258 g/L based on the volume of the ceramic support. Applied to the first washcoat layer is a further washcoat layer B containing Pt and Pd, and also Rh, supported on a lanthanum-stabilized alumina. The loading of Pt, Pd and Rh in this washcoat layer is 20 g/cft (0.706 g/L), 10 g/cft (0.353 g/L) and 5 g/cft (0.177 g/L). The washcoat layer B also contains 55 g/L of cerium oxide with a washcoat loading of layer B of 100 g/L.

1. A nitrogen oxide storage catalyst composed of at least two catalytically active washcoat layers on a support body,
wherein
a lower washcoat layer A contains cerium oxide, an alkaline earth metal compound and/or an alkali metal compound, and also platinum, and
an upper washcoat layer B disposed atop the washcoat layer A contains cerium oxide, and also platinum and/or palladium, and no alkaline earth metal compound,
and wherein the washcoat layer B is present in an amount of 50 to 200 g/L, based on the volume of the support body, and the minimum proportion by mass in % of cerium oxide in the washcoat layer B is calculated from the formula
0.1×amount of washcoat layer B in g/L+30.

2. The nitrogen oxide storage catalyst as claimed in claim 1, wherein the washcoat layer A contains cerium oxide in an amount of 30 to 100 g/L.

3. The nitrogen oxide storage catalyst as claimed in claim 1, wherein the washcoat layer B is present in an amount of 80 to 130 g/L, based on the volume of the support body.

4. The nitrogen oxide storage catalyst as claimed in claim 1, wherein the proportion by mass of cerium oxide in the washcoat layer B is at least 50%.

5. The nitrogen oxide storage catalyst as claimed in claim 1, wherein the washcoat layer B does not contain any alkali metal compound.

6. The nitrogen oxide storage catalyst as claimed in claim 1, wherein the washcoat layer A and the washcoat layer B each contain platinum and palladium.

7. The nitrogen oxide storage catalyst as claimed in claim 6, wherein the ratio of platinum to palladium is 1:2 to 20:1.

8. The nitrogen oxide storage catalyst as claimed in claim 1, wherein the washcoat layer A contains an alkaline earth metal compound and/or alkali metal compound in amounts of 10 to 50 g/L, based on the volume of the support body.

9. The nitrogen oxide storage catalyst as claimed in claim 1, wherein the alkaline earth metal compound in washcoat layer A is barium oxide or strontium oxide.

10. The nitrogen oxide storage catalyst as claimed in claim 1, wherein it comprises
a lower washcoat layer A containing
cerium oxide in an amount of 30 to 80 g/L,
platinum and palladium in a ratio of 10:1, and
barium oxide; and
an upper washcoat layer B is disposed atop the lower washcoat layer A and contains
no alkaline earth metal compound and no alkali metal compound,
platinum and palladium in a ratio of 10:1, and
cerium oxide in an amount of 40 to 100 g/L,
wherein the washcoat layer B is present in amounts of 80 to 130 g/L and wherein the unit g/L is based in each case on the volume of the support body.

11. A method for converting NOₓ in the exhaust gases of motor vehicles which are operated with lean-burn engines, wherein the exhaust gas is passed over a nitrogen oxide storage catalyst composed of at least two catalytically active washcoat layers on a support body,
wherein
a lower washcoat layer A contains cerium oxide, an alkaline earth metal compound and/or an alkali metal compound, and also platinum, and
an upper washcoat layer B disposed atop the washcoat layer A contains cerium oxide, and also platinum and/or palladium, and no alkaline earth metal compound,
and wherein the washcoat layer B is present in an amount of 50 to 200 g/L, based on the volume of the support body, and the minimum proportion by mass in % of cerium oxide in the washcoat layer B is calculated from the formula
0.1×amount of washcoat layer B in g/L+30.
